(19) United States
(12) Patent Application Publication
(10) Pub. No.: US 2025/0229487 A1
(43) Pub. Date: Jul. 17, 2025

(54) VARIABLE-SIZED THREE-DIMENSIONAL PRINTING HEAD ASSEMBLY

(71) Applicant: Yarmouk University, Irbid (JO)

(72) Inventors: Mahdi Jamil AL QURAN, Zarqa (JO); Momen Mohammad QASAIMEH, Zarqa (JO); Abdel Monem M. RAWASHDEH, Irbid (JO)

(73) Assignee: Yarmouk University, Irbid (JO)

(21) Appl. No.: 19/015,957

(22) Filed: Jan. 10, 2025

Related U.S. Application Data
(60) Provisional application No. 63/619,757, filed on Jan. 11, 2024.

(51) Int. Cl. B29C 64/209; B29C 64/295; B33Y 30/00

(52) U.S. Cl. CPC B29C 64/209; B29C 64/295; B33Y 30/00

(57) ABSTRACT

A three-dimensional variable-size printing head assembly including a first base and a second base connected via a vertical alignment rod, a hot extruder assembly, driven gear and driver gear assemblies, a vertical movement assembly, one or more guiding wheels, and a spring plunger. The driven gear assembly, with multiple extrusion heads and mounting hardware, works in conjunction with the driver gear assembly to facilitate precise nozzle size switching. This configuration allows for accurate and repeatable changes between nozzle sizes, enhancing the overall performance and versatility of the 3D printing process.

### CROSS-REFERENCE TO EARLIER APPLICATION

The present application claims priority from the provisional U.S. patent application No. 63/619,757 filed on Jan. 11, 2024, which is incorporated herein by reference.

### TECHNICAL FIELD

The present invention relates to additive manufacturing and three-dimensional (“3D”) printers' field, and in particular a 3D printer extruder head having changeable nozzle heads with different sizes.

### BACKGROUND INFORMATION

In recent years, additive manufacturing, commonly referred to as 3D printing, has undergone significant change. The scope of designers' inventiveness and creativity has significantly expanded with the fast development of these technologies, especially in conjunction with computer-aided design (“CAD”). The former technology is essential to the revolution in CAD-3D printing because it makes it easier for concepts to be transformed into 3D models with computer aid. In addition, the latter makes it possible to produce extremely complicated and detailed pieces that were previously unachievable with traditional subtractive processes. In reality, a great deal of research has been done to improve and reduce the prices of additive manufacturing techniques.

One of the most popular additive manufacturing techniques, fused deposition modeling, divides the CAD model into layers based on the nozzle size that is preloaded. To build the model layer by layer, a heated nozzle constantly delivers plastic filament from a canister or spool. The nozzle's diameter determines the layer's height and width. The small layer size is crucial when trying to construct smooth or high-precision model features. However, the printing process is slower the smaller the layer size. The majority of 3D models are mostly made up of both low-resolution and finely detailed components. As a result, designers typically aim to achieve the best possible balance between printing speed and accuracy. Thus, the development of a printing head with simultaneous in-process variable-size plastic deposition capabilities is fueled by this crucial limitation.

The Chinese patent 106426908A discloses a variable-caliber 3D printer extrusion head and a printing method thereof. The variable-caliber 3D printer extrusion head comprises a feeding cylinder and an adjusting rotary disc. A through hole is formed in the feeding cylinder along the central axis. An opening in the top of the feeding cylinder is a feeding opening, and an opening in the bottom of the feeding cylinder is connected with the adjusting rotary disc. The adjusting rotary disc comprises an upper rotary disc body, a lower rotary disc body and multiple inlaid plates wrapped and sandwiched between the upper rotary disc body and the lower rotary disc body. The adjusting rotary disc can rotate relative to the feeding cylinder, all of the inlaid plates slide relatively through a guiding device, the aperture of a formed discharging hole can become large and small, and the section of the discharging hole is maintained to be a positive polygon in equal-proportion scaling.

The Korean patent 101725302B1 shows a nozzle of a three-dimensional printer, in which a plurality of cylindrical nozzle members having different diameters are laminated in a concentric manner, and the nozzle members are independently lifted up and down by a driving unit, thereby reducing the strength and precision of the connecting portion between the nozzle and the structure in which the nozzle is mounted, and preventing the output time from being significantly shortened.

### SUMMARY

The present invention pertains to a 3D variable-size printing head assembly that ensures precision and dependability in 3D printing applications. This assembly integrates several critical components, including a first base, a second base, a hot extruder assembly, a driven gear assembly, a driver gear assembly, a vertical movement assembly, guiding wheels, a vertical alignment rod, and a spring plunger.

The first and second bases are interconnected via a vertical alignment rod, which ensures stable vertical movement. Guiding wheels attached to the first base facilitate smooth navigation along the printer rails. The vertical movement assembly, composed of a stepper motor, lead screw coupler, lead screw, and lead screw nut, controls the elevation of the second base and the hot extruder assembly, allowing precise vertical adjustments.

The hot extruder assembly comprises a heat sink, heating block, nozzle, and insulation case, among other components. The heat sink is designed to keep the filament cool before it reaches the heating block, preventing clogs. It features multiple cooling fins and air channels for efficient heat dissipation. The heating block includes sleeves for a heating element and temperature sensor, ensuring the filament is heated accurately and consistently.

The driven gear assembly, featuring a central driven gear, upper cover, multiple extrusion heads, and associated mounting hardware, facilitates the rotational movement needed for precise nozzle size switching. The driven gear is meshed with the driver gear, which is attached to a stepper motor in the driver gear assembly. This setup enables accurate and repeatable switching between different nozzle sizes, enhancing the versatility and efficiency of the 3D printing process.

The integration of these assemblies allows for high precision and adaptability in 3D printing, making this invention a significant advancement in the field.

### BRIEF DESCRIPTION OF DRA WINGS

The disclosure will now be described with reference to the accompanying drawings, which illustrate embodiments of the present disclosure, without restricting the scope of the disclosure, and in which:

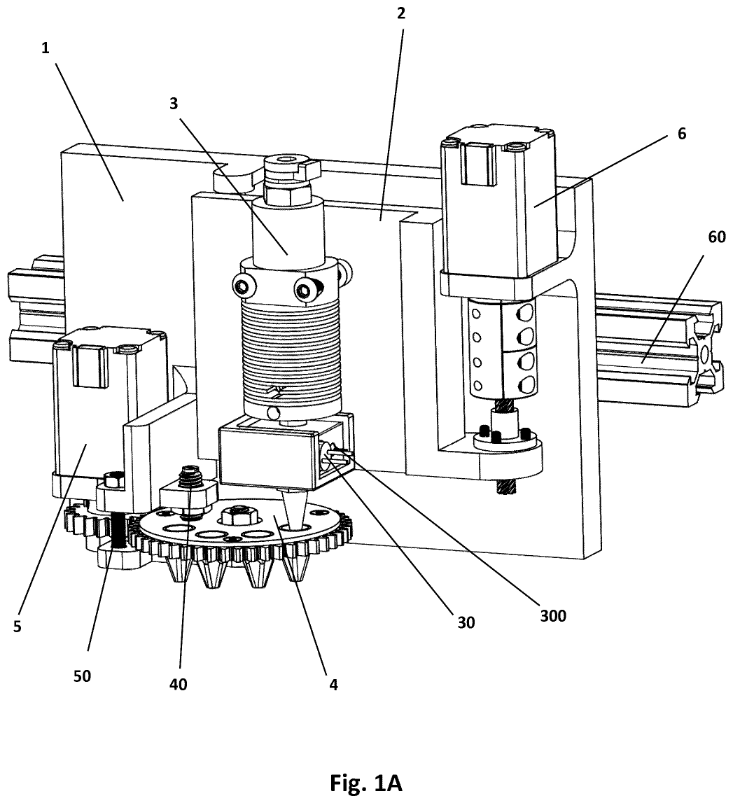

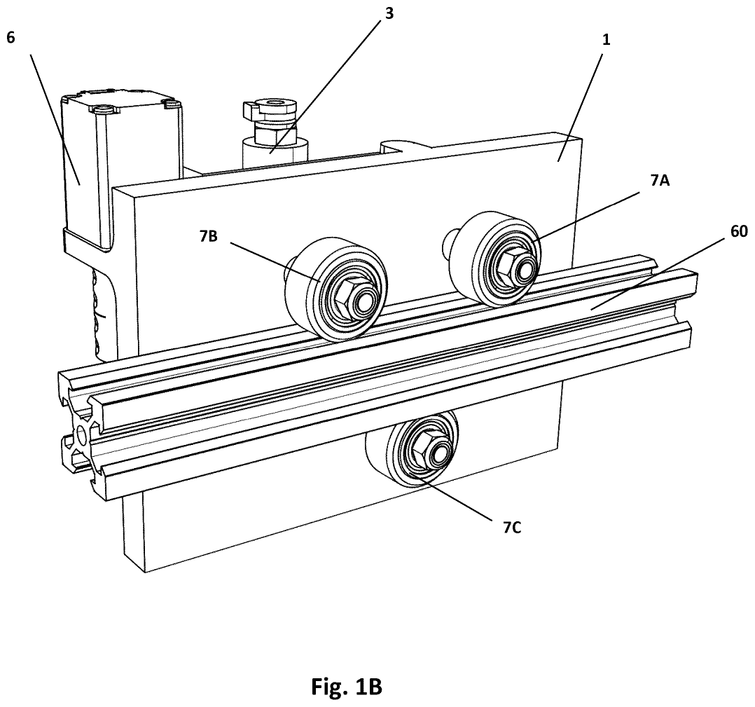

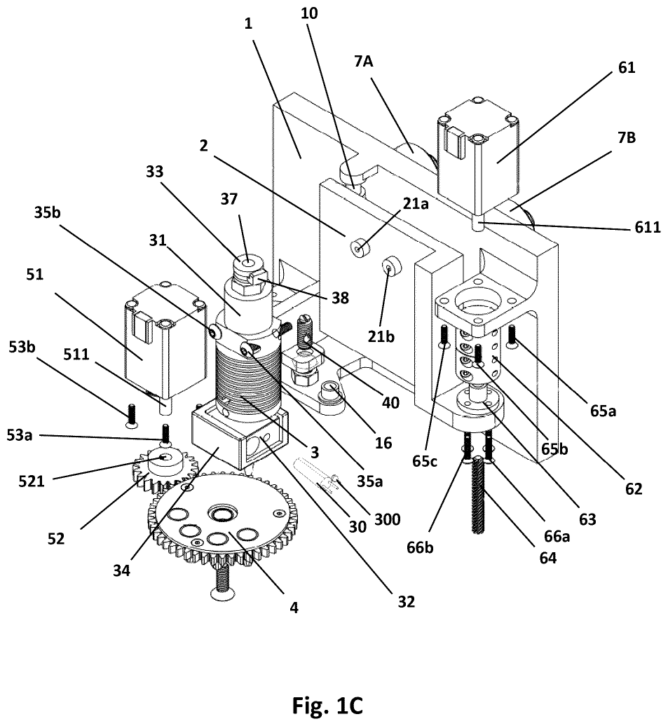

FIG. 1A illustrates a frontal perspective view of a variable-sized 3D printing head assembly for a 3D printer configured in accordance with embodiments of the present disclosure.

FIG. 1B illustrates a back-perspective view of a variable-sized 3D printing head assembly for a 3D printer configured in accordance with embodiments of the present disclosure.

FIG. 1C illustrates an exploded perspective view of a variable-sized 3D printing head assembly for a 3D printer configured in accordance with embodiments of the present disclosure.

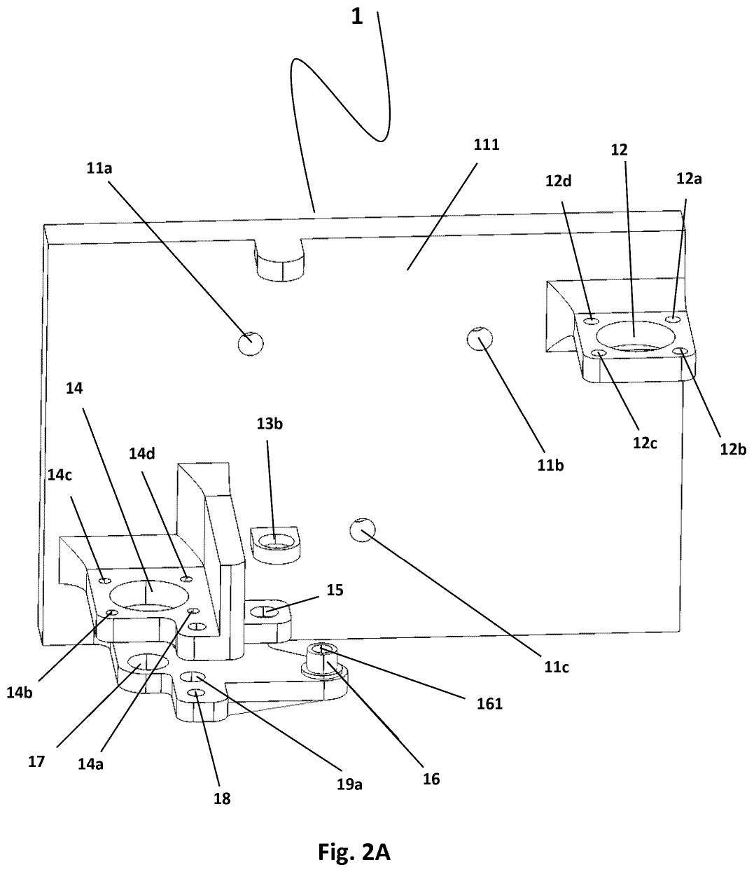

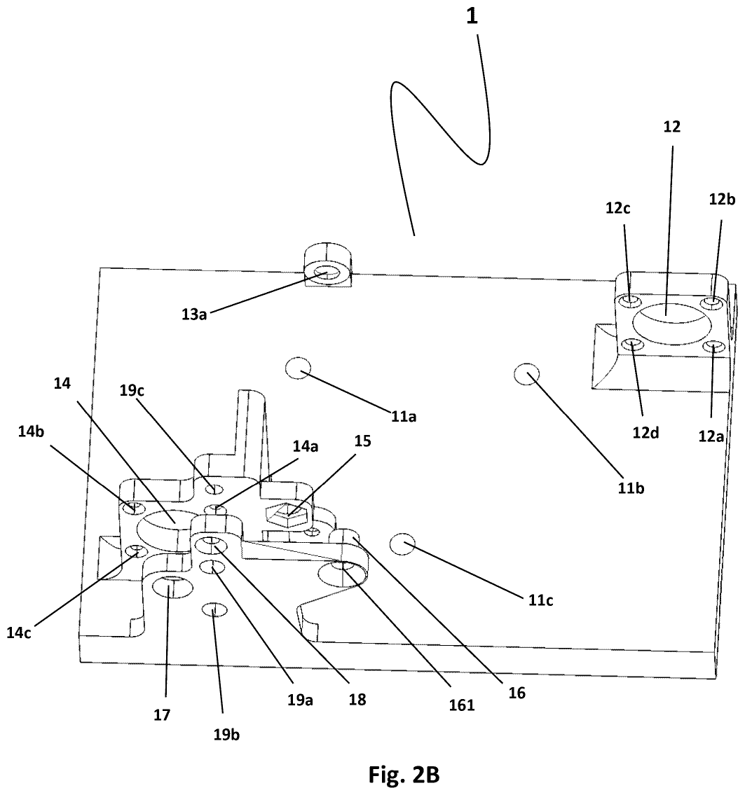

FIG. 2A illustrates a frontal perspective view of a first base of a variable-sized 3D printing head assembly configured in accordance with embodiments of the present disclosure.

FIG. 2B illustrates a back-perspective view of a first base of a variable-sized 3D printing head assembly configured in accordance with embodiments of the present disclosure.

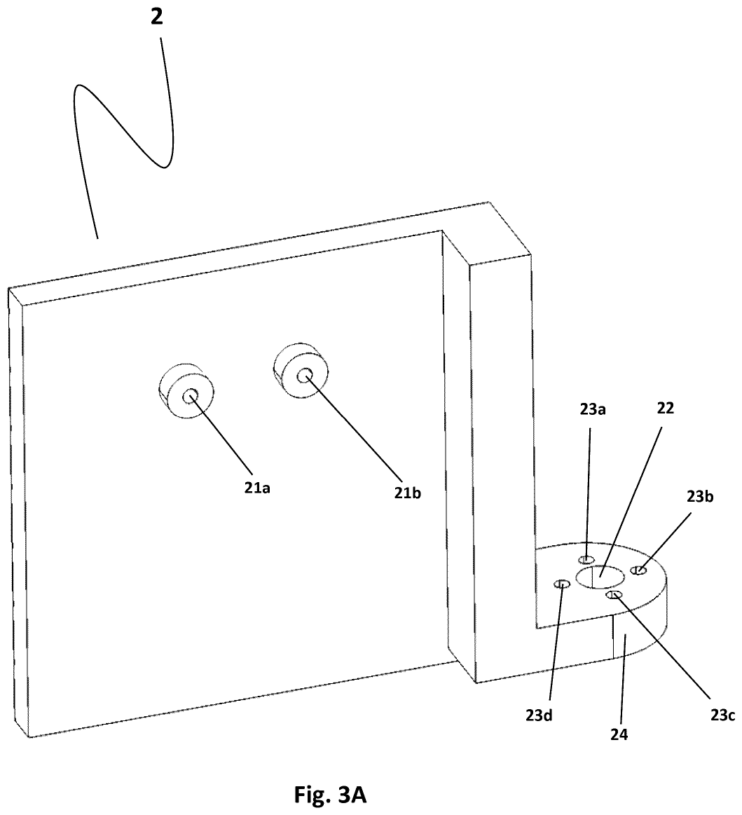

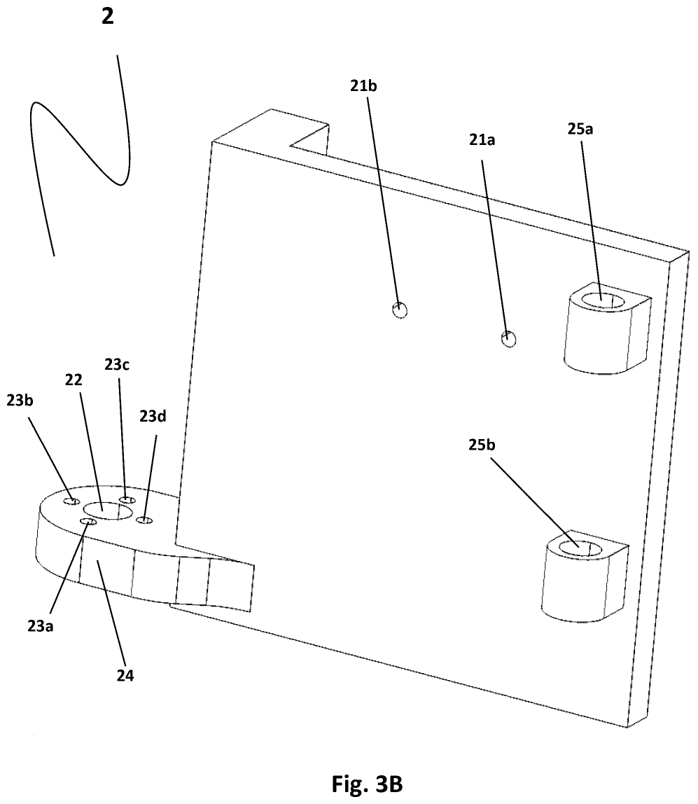

FIG. 3A illustrates a frontal perspective view of a second base of a variable-sized 3D printing head assembly configured in accordance with embodiments of the present disclosure.

FIG. 3B illustrates a back-perspective view of a second base of a variable-sized 3D printing head assembly configured in accordance with embodiments of the present disclosure.

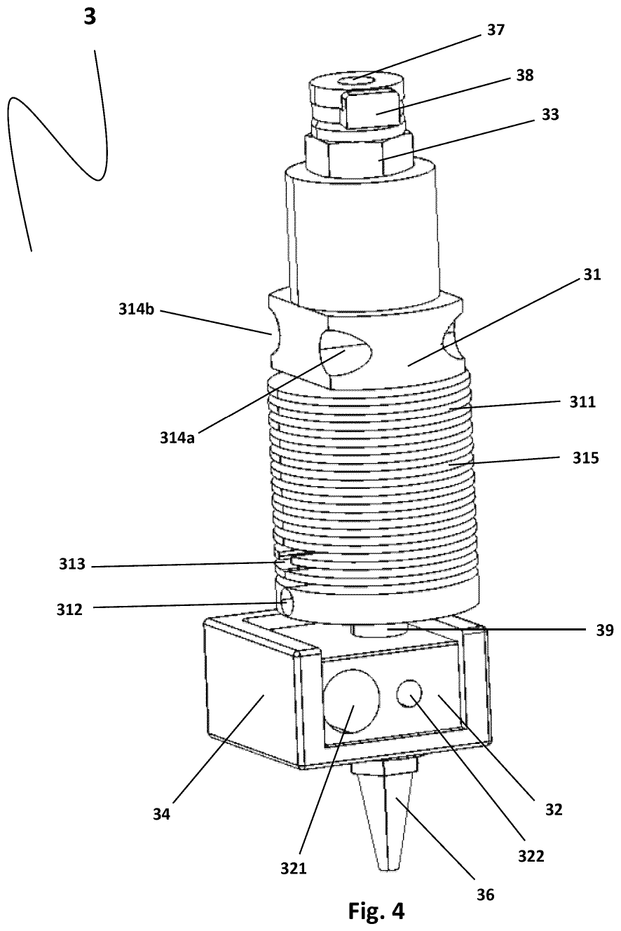

FIG. 4 illustrates a perspective view of an extruder assembly of a variable-sized 3D printing head assembly configured in accordance with embodiments of the present disclosure.

FIG. 5A illustrates a top perspective view of a driven gear assembly of a variable-sized 3D printing head assembly configured in accordance with embodiments of the present disclosure.

FIG. 5B illustrates a top perspective view of a driven gear of a variable-sized 3D printing head assembly configured in accordance with embodiments of the present disclosure.

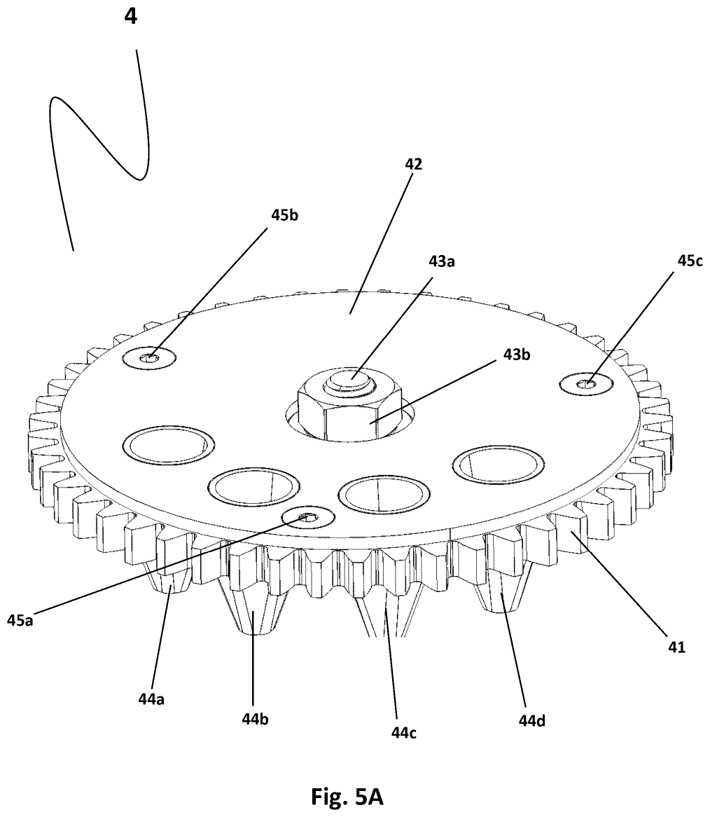

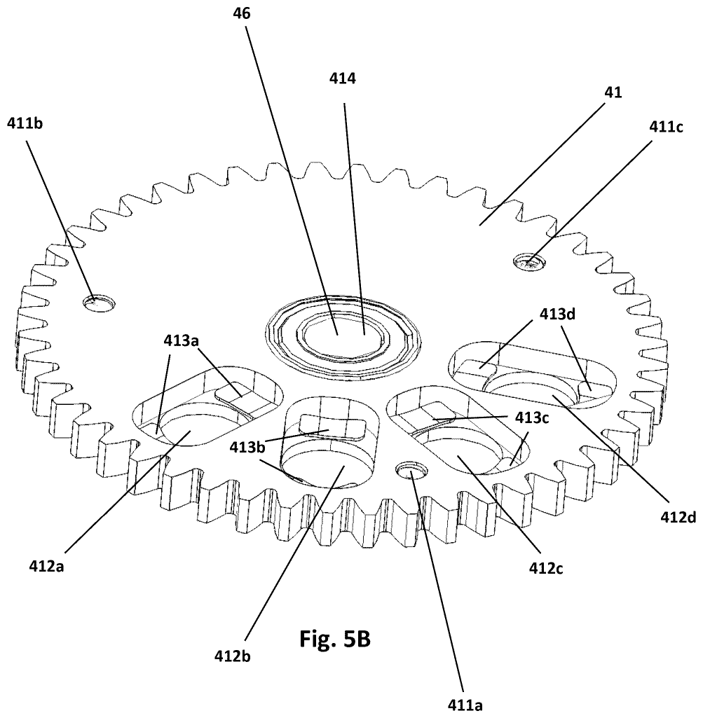

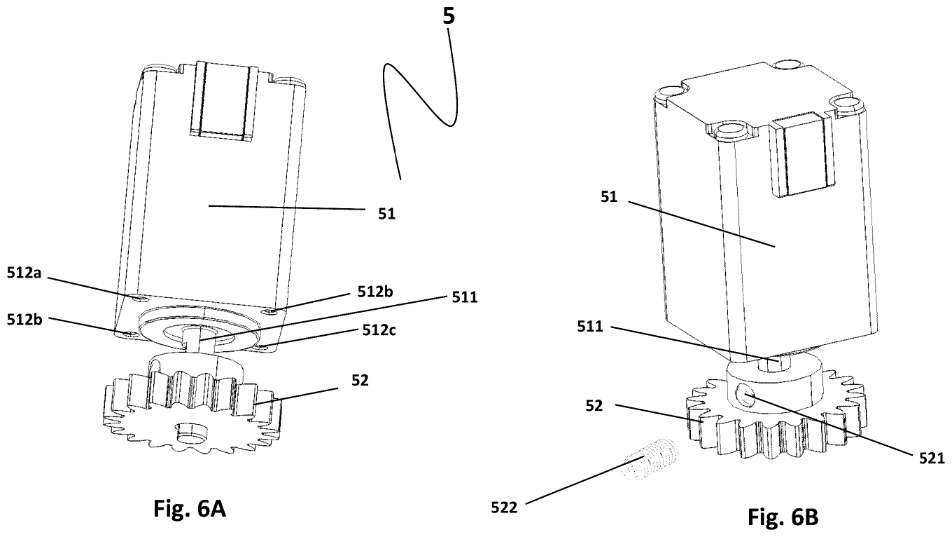

FIG. 6A illustrates a bottom perspective view of a driver gear assembly of a variable-sized 3D printing head assembly configured in accordance with embodiments of the present disclosure.

FIG. 6B illustrates a top perspective view of a driver gear assembly of a variable-sized 3D printing head assembly configured in accordance with embodiments of the present disclosure.

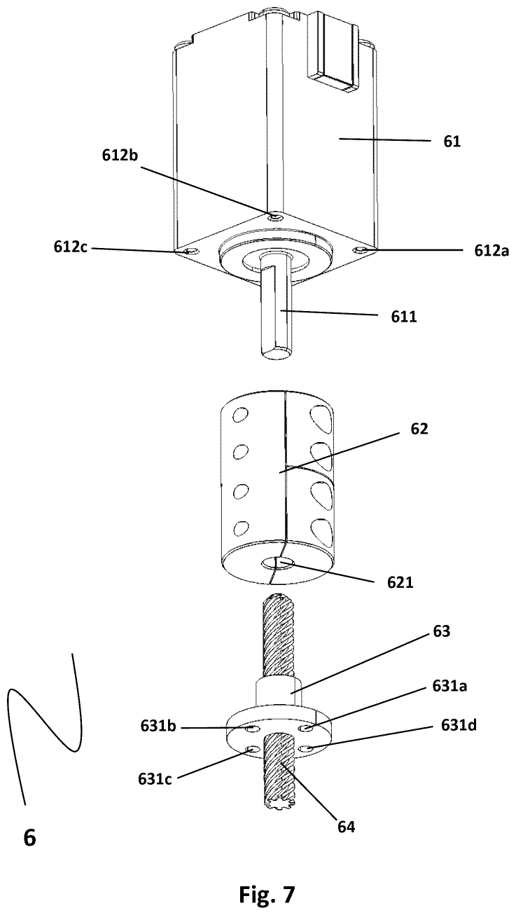

FIG. 7 illustrates an exploded isometric view of a driven gear assembly of a variable-sized 3D printing head assembly configured a in accordance with embodiments of the present disclosure.

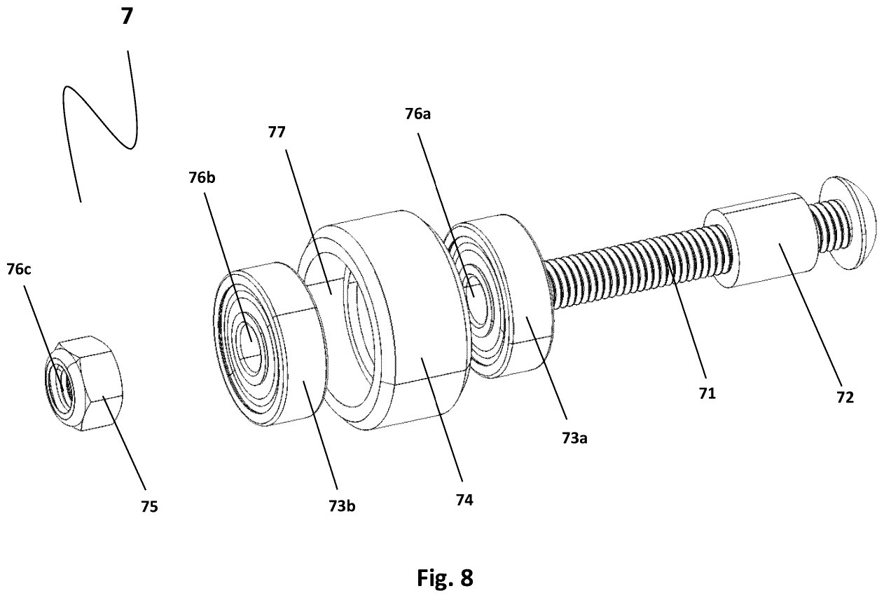

FIG. 8 illustrates a schematic diagram of a top perspective view of a wheel assembly of a variable-sized 3D printing head assembly configured in accordance with embodiments of the present disclosure.

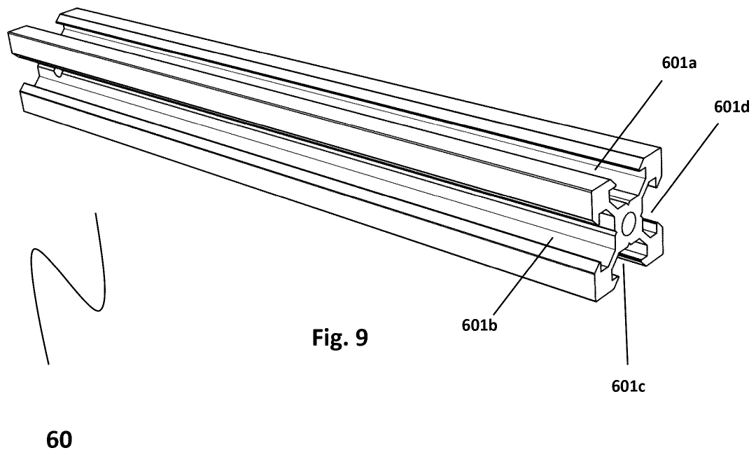

FIG. 9 illustrates a top perspective view of a guiding rail of a variable-sized 3D printing head assembly configured in accordance with embodiments of the present disclosure.

### DETAILED DESCRIPTION

Referring to FIGS. 1A-1C, the present disclosure provides a 3D variable-size printing head assembly. This 3D variable-size printing head assembly includes a first base 1, a second base 2, a hot extruder assembly 3, a driven gear assembly 4, a driver gear assembly 5, a vertical movement assembly 6, one or more guiding wheels 7a, 7b, and 7c, a vertical alignment rod 10 with a first end and a second end, and a spring plunger 40.

Referring to FIGS. 2A-3B, the first base 1 is connected to the second base 2 via the vertical alignment rod 10, wherein a first end of the rod 10 fits securely into an upper bore 13a (FIG. 2B) and extends through sleeves 25a and 25b of the second base 2 (FIG. 3B), while a second end of the rod 10 fits securely into a lower bore 13b (FIG. 2A).

Referring now to FIGS. 1B-2A, 7, and 8, the 3D variable-size printing head assembly is guided and driven on a 3D printer rail 60 by the one or more guiding wheels 7a, 7b, and 7c, wherein the one or more wheels are configured to be driven on one or more elongated grooves 601a and 601c. These one or more guiding wheels are attached to the first base 1 by screws 71 through openings 11a, 11b, and 11c and secured with three nuts 75. Each of the one or more guiding wheels 7a, 7b, and 7c has of a tire 74, two bearings 73a, 73b, and a spacer 72. The bearings 73a, 73b are configured to fit into an opening 77, while the screw 71 fits into openings 76a, 76b, 76c of the one or more guiding wheels 7a, 7b, 7c.

Additionally, in embodiments of the present disclosure, the first base 1 is also connected to the second base 2 by the vertical movement assembly 6 (FIG. 1A). The vertical movement assembly 6 includes a stepper motor 61 with a stepper motor shaft 611, a lead screw coupler 62, a lead screw nut 63, and a lead screw 64 (FIG. 7). The stepper motor 61 is attached to the first base 1 using one or more screws 65a, 65b, 65c, 65d through corresponding openings 12a, 12b, 12c, 12d (FIGS. 1C, 2A). The stepper motor shaft 611 is connected to the lead screw coupler 62 by fitting into a sleeve 621 in the lead screw coupler 62. The sleeve 621 further houses the lead screw 64. The lead screw nut 63 is secured to the second base 2 with lead screw nut screws 66a, 66b, 66c, 66d through openings 631a, 631b, 631c, and 631d. The lead screw nut 63 includes a sleeve configured to house the lead screw 64 (FIGS. 1C, 7).

In embodiments of the present disclosure, the rotation of the stepper motor 61 will rotate the lead screw coupler 62 resulting in the rotation of the lead screw 64, which will increase or decrease the displacement of the second base 2 relative to the first base 1, thus, controlling the elevation of the hot extruder assembly 3 and changing the size of the hot extruder tip.

Referring to FIGS. 4, 5A, 5B, 6A-7, the hot extruder assembly 3 includes a heat sink 31 with an upper end and a lower end, a heating block 32, a screw connector 33, a nozzle 36, a locking clip 38, a heat throat 39, and an insulation case 34. The upper end of the heat sink 31 is designed to connect with the screw connector 33, wherein the screw connector 33 includes an opening 37 extending to a lower portion of the hot extruder assembly, allowing a printing filament to pass through. The heating block 32 includes a heating element sleeve 321 and a temperature sensor sleeve 322, both configured to house a heating element 30 and a temperature sensor 300, respectively. The heating element, connected to a power source (not shown), heats the filament to a specific temperature. The temperature sensor monitors and regulates the heating element's temperature. The nozzle 36 is designed to extrude the heated filament through its smaller opening. The insulation case 34 serves to insulate the heat generated by the heating block 32.

The heat sink 31 is configured to maintain a filament segment cool before entering the heating block 32. This prevents the opening 37 from clogging, while ensuring smooth and uninterrupted filament flow during the 3D printing process. The heat sink 31 is made of one or more rigid materials with a high thermal conductivity, such as aluminum or copper, to efficiently dissipate heat away from the filament.

The heat sink 31 includes multiple cooling fins 311 arranged in a parallel configuration. These fins significantly increase the surface area exposed to the ambient air, thereby enhancing the heat dissipation rate. The cooling fins 311 are thin, elongated structures that extend outward from the central body of the heat sink 31. The heat throat 39 is a hollow cylindrical shaped element configured to connect the heat sink 31 and the heating block 32 with each other. The heat sink 31 and the heating block 32 are configured to fit snugly on the heat throat 39.

The heat sink 31 includes an attachment mechanism at its lower end, allowing it to be securely mounted directly to the heating throat 39. This attachment mechanism typically consists of screw holes 312, 313 and corresponding screws (not shown), providing a stable and vibration-free connection. The secure attachment is crucial to maintaining the proper alignment and effectiveness of the heat sink 31.

In embodiments of the present disclosure, the heat sink 31 may further include an additional attachment mechanism, allowing the hot extruder assembly 3 to be securely mounted directly to the second base 2. This additional attachment mechanism typically includes screw holes 314a, 314b and corresponding screws 35a, 35b, providing a stable and vibration-free connection.

The heat sink 31 in embodiments of the present disclosure further includes a plurality of air channels 315 positioned between the cooling fins 311. Such air channels 315 facilitate the flow of air through the heat sink 31, promoting efficient heat transfer from the opening 37 to the surrounding environment. The plurality of air channels 315 are configured to maximize airflow while minimizing resistance, ensuring continuous and effective cooling.

With reference to FIGS. 1A, 1C, 5A and 5B, the driven gear assembly 4 is configured to facilitate the rotational movement and precise positioning of nozzle size switching. This driven gear assembly 4 enables the selection and activation of different nozzle sizes, thereby enhancing the versatility and efficiency of the 3D printing process.

In embodiments of the present disclosure, the driven gear assembly 4 includes a driven gear 41, an upper cover 42, a bolt 43a, a nut 43b, one or more cover screws 45a, 45b, 45c, and one or more extrusion heads, 44a, 44b, 44c, and 44d.

The driven gear 41 serves as the central element of the assembly 4 with an array of teeth around its circumference for meshing with the driver gear assembly 5. At the center of the driven gear 41 is a center opening 46, which accommodates a bearing 414 for smooth rotational movement and reduced friction during operation.

Secured to the driven gear 41 is the upper cover 42, affixed by the one or more cover screws 45a, 45b, and 45c. These one or more cover screws pass through corresponding upper cover screw openings 411a, 411b, 411c on the driven gear, ensuring the upper cover is firmly attached. The upper cover 42 is configured to protect the internal components and maintain the structural integrity of the assembly.

The driven gear assembly 4 further includes a central bolt 43a and a nut 43b configured to lock the components together, providing additional stability to the structure. The driven gear assembly 4 is fixed to rotate on the first base 1 by the central bolt 43a and the nut 43b, the central bolt 43a is configured to pass through the center opening 46 and a hollow extrusion 16 and then fastened by the nut 43b. The hollow extrusion 16 is configured to fit inside the bearing 414 of the central opening 46. Additionally, the driven gear assembly 4 is further supported by a spring plunger 40 which is configured to screw in opening 15 and support the assembly 4.

In embodiments of the present disclosure, each of the one or more extrusion heads 44a, 44b, 44c, 44d has a differ size and is configured to accommodate various printing size requirements. These one or more extrusion heads are configured to be inserted in corresponding one or more extrusion head openings 412a, 412b, 412c, and 412d on the driven gear 41. Each of the one or more extrusion head openings 412a, 412b, 412c, and 412d has one or more mountings 413a, 413b, 413c, 414d in for the extrusion heads ensures they are securely fixed and precisely aligned for effective material deposition and ensure there is no material leakage due to the connection between the Nozzle 36 and one of the extrusion head 44a, 44b, 44c or 44d.

This driven gear assembly 4 is configured enable quick and accurate switching between different nozzle sizes, thereby enhancing the versatility and efficiency of 3D printers.

The driver gear assembly 5 depicted in FIGS. 1C, 2A, 6A and 6B is configured to facilitate the rotation and positioning of the driven gear within the embodiments of the present disclosure. The driver gear assembly includes a stepper motor 51 and a driver gear 52 that work together to achieve a precise control over the nozzle switching mechanism.

The stepper motor 51 serves as a primary actuator, converting electrical signals into mechanical rotation. The stepper motor 51 is equipped with a shaft 511 that extends and connects to the driver gear 52. The stepper motor is securely mounted through stepper motor screw openings 512a, 512b, 512c, and 512d. These stepper motor screws openings are configured to accommodate screws 53a, 53b, 53c, and 53d, which pass through openings 14a, 14b, 14c, and 14d and ensure that the stepper motor 51 is firmly attached to the first base 1.

In embodiments of the present disclosure, the driver gear 52 is mounted onto the shaft 511 of the stepper motor. The driver gear 52 has teeth that mesh with the teeth of the driven gear 41 to transmit rotational motion. This arrangement allows for the precise positioning of the driven gear 52 and, consequently, the switching of different nozzle sizes.

The driver gear 52 has a bolt opening 521 configured to secure the driver gear 52 onto the shaft 511 of the stepper motor 51. A bolt 522 is inserted through this opening to lock the driver gear 52 in place, preventing any slippage during operation. This ensures that the rotational motion of the stepper motor 51 is accurately transferred to the driven gear 52.

The configuration of the driver gear assembly 5 allows for precise control over the movement and positioning of the nozzle switching mechanism. By integrating the stepper motor 51 with the driver gear 52, the system can achieve high levels of accuracy and repeatability in switching between different nozzle sizes.

The use of the term “and” in the claims is used to mean “and/or” unless explicitly indicated to refer to a collective nature only. The singular forms “a,” “an,” and “the” include plural referents unless the context clearly dictates otherwise.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a defacto equivalent of any other member of the same list solely based on their presentation in a common group without indications to the contrary.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

While the present disclosure has been made in detail and with reference to specific embodiments, it will be apparent to those skilled in the art that various additions, omissions, or amendments can be made without departing from the scope and spirit thereof.

What is claimed is:

1. A three-dimensional variable-size printing head assembly, comprising:
a first base;
a second base connected to the first base via a vertical alignment rod, wherein the second base is movable relative to the first base;
a hot extruder assembly connected to the second base;
a driven gear assembly;
a driver gear assembly; and
a vertical movement assembly configured to move the second base relative to the first base;
wherein the three-dimensional variable-size printing head assembly is configured to allow an adjustment of a tip size of the hot extruder.

2. The three-dimensional variable-size printing head assembly of claim 1, wherein the hot extruder assembly comprises:
a heat sink having a plurality of cooling fins and air channels;
a heating block having a heating element and a temperature sensor, the heating block is configured to heat a printing filament;
a nozzle designed to extrude a heated printing filament through a nozzle tip;
an insulation case configured to insulate heat generated by the heating block.

3. The three-dimensional variable-size printing head assembly of claim 1, wherein the driven gear assembly comprises:
a driven gear with a plurality of teeth configured to engage with the driver gear assembly;
one or more extrusion heads of varying nozzle sizes;
a cover;
a central bolt and nut;
a bearing configured to provide a smooth rotational movement and reduced friction of the driven gear; and
a spring plunger;

4. The three-dimensional variable-size printing head assembly of claim 1, wherein the driver gear assembly comprises:
a stepper motor with a shaft;
a driver gear with a plurality of teeth configured to engage with the driven gear assembly, the driver gear is configured to be mounted onto the stepper motor shaft;
one or more stepper motor screw openings for securely mounting the motor; and
a bolt and a bolt opening to secure the driver gear onto the stepper motor shaft.

5. The three-dimensional variable-size printing head assembly of claim 1, wherein the spring plunger supports the driven gear assembly to provide an additional stability.

6. The three-dimensional variable-size printing head assembly of claim 1, wherein the vertical movement assembly comprises:
a second stepper motor having a stepper motor shaft;
a lead screw coupler;
a lead screw nut;
a lead screw;
wherein the vertical movement assembly is configured to allow for precise vertical adjustments of the hot extruder assembly relative to the first base.

7. The three-dimensional variable-size printing head assembly of claim 6, wherein the lead screw coupler of the vertical movement assembly connects the lead screw to the shaft of the second stepper motor.
